(19) United States
(12) Patent Application Publication
(10) Pub. No.: US 2013/0318735 A1
(43) Pub. Date: Dec. 5, 2013

(54) WINDSCREEN WIPER DEVICE

(71) Applicant: Davy Mouth, Aubange (BE)

(72) Inventor: Davy Mouth, Aubange (BE)

(21) Appl. No.: 13/991,255

(22) PCT Filed: Dec. 2, 2010
(86) PCT No.: PCT/EP10/68727

§ 371 Date: Aug. 13, 2013

(51) Int. Cl. B60S 1/40

(52) U.S. Cl. CPC B60S 1/4006
USPC 15/250.32

(57) ABSTRACT

A windscreen wiper device comprising an elastic, elongated carrier element, as well as an elongated wiper blade of the flat blade type, a mounting head for transferring a reciprocal movement to said wiper blade, as well as a connecting device for an oscillating arm with the interposition of a joint part, wherein said joint part comprises at least one resilient tongue engaging in a correspondingly shaped hole provided in said oscillating arm, wherein said oscillating arm has an U-shaped cross-section at the location of its connection to said joint part, with the special feature that said oscillating arm and said joint part are interconnected by introduction of said joint part inside the U-shaped cross-section of said oscillating arm at a location between the hole provided in said oscillating arm and said mounting head.

### BACKGROUND OF THE INVENTION

### Technical Field

The present invention relates to a windscreen wiper device comprising an elastic, elongated carrier element, as well as an elongated wiper blade of a flexible material, which can be placed in abutment with a windscreen to be wiped, which wiper blade is of the flat blade type and includes at least one longitudinal groove, in which groove a longitudinal strip of the carrier element is disposed, which windscreen wiper device comprises a mounting head for transferring a reciprocal movement to the wiper blade, as well as a connecting device for an oscillating arm, wherein the oscillating arm is pivotally connected to the connecting device about a pivot axis near a free end thereof, with the interposition of a joint part, wherein the joint part comprises at least one resilient tongue engaging in a correspondingly shaped hole provided in the oscillating arm, and wherein the resilient tongue is rotatable along an hinge axis between an outward position retaining the wiper blade onto the oscillating arm and an inward position releasing the wiper blade from the oscillating arm, wherein the oscillating arm has an at least substantially U-shaped cross-section at the location of its connection to the joint part, and wherein the joint part is positioned at least substantially within the U-shaped cross-section of the oscillating arm.

It is noted that the present invention is not restricted to cars, but also refers to rail coaches and other (fast) vehicles.

Such a windscreen wiper device is known from international patent publication no. WO 2010/017861 (Volkswagen). This prior art windscreen wiper blade is designed as a “yokeless” wiper blade or flat blade, wherein no use is made of several yokes pivotally connected to each other, but wherein the wiper blade is biased by the carrier element, as a result of which it exhibits a specific curvature. The wiper blade and the oscillating arm of the known windscreen wiper device are interconnected through a so-called “bayonet connection”, wherein the resilient tongue on the joint part is initially pushed in against a spring force—as if it were a push button—and then allowed to spring back into the hole provided in the oscillating arm, thus snapping, that is clipping the resilient tongue into the hole. By subsequently pushing in again the resilient tongue against the spring force, the wiper blade may be released from the oscillating arm. The oscillating arm of the known windscreen wiper device is provided with an opening at its free end for sliding the joint part through this opening in order to connect the wiper blade to the oscillating arm thereof.

A disadvantage of the windscreen wiper arm known from the above European patent publication is that in practice it has become apparent that the wiping qualities of the wiper blade involved can be improved.

### SUMMARY OF THE INVENTION

It is an object to obviate this disadvantage, in the sense that at minimum costs—without using complex machinery and additional tools—a simple though effective windscreen wiper device is proposed, wherein the wiping properties are of the highest level.

Thereto, a windshield wiper device mentioned in the preamble is characterized in that the oscillating arm and the joint part are interconnected by introduction of the joint part inside the U-shaped cross-section of the oscillating arm at a location between the hole provided in the oscillating arm and the mounting head. In other words, the joint part (the connecting device and the wiper blade are attached thereto) is mounted onto the oscillating arm inside the U-shaped cross-section thereof at a location before (instead of after) the hole in the oscillating arm, seen from the mounting head towards the free end of the oscillating arm. As the joint part does not have to enter an opening at the free end of the oscillating arm, like in the prior art, the oscillating arm can be designed shorter than in the prior art. Accordingly, the wiper blade can follow more effectively any curvatures of windscreens to be wiped, with all consequences of better wiping properties involved, as the free end of the oscillating arm is closer to the connecting device than in the prior art. As the free end of the oscillating arm is then also closer to the wiper blade, in the present invention there is less risk that the oscillating arm is trapped during car washing.

The joint part is preferably made of plastic.

In a preferred embodiment of a windscreen wiper device the U-shaped cross-section of the oscillating arm comprises guiding means at a location between the hole provided in the oscillating arm and the mounting head for guiding the joint part inside the U-shaped cross-section of the oscillating arm. the guiding means are particularly formed on inner sides of legs of the U-shaped cross-section, preferably in the form of guiding ribs.

In another preferred embodiment of a windscreen wiper device the hinge axis of the joint part is facing towards the free end of the oscillating arm. In the alternative, the hinge axis of the joint part is facing away from the free end of the oscillating arm.

In another preferred embodiment of a windscreen wiper device the hole of the oscillating arm is provided in a base of the U-shaped cross-section thereof. Preferably, the hole has a closed circumference.

In another preferred embodiment of a windscreen wiper device the joint part is attached to the connecting device by pivotally engaging protrusions of the connecting device, at the location of the pivot axis, in recesses provided in the joint part. Particularly, the joint part has an at least substantially U-shaped cross-section at the location of its attachment to the connecting device, and wherein the joint part in each leg of the U-shaped cross-section is provided with a recess provided coaxially with the pivot axis. Preferably, the protrusions extend outwards on either side of aid connecting device, wherein the protrusions are at least substantially cylindrical.

### THE DRAWINGS

Embodiments will now be explained in more detail with reference to figures illustrated in a drawing, wherein:

FIGS. 1 through 3 show various successive steps for fitting the joint part/connecting device and the oscillating arm of a windscreen wiper device together according to a preferred embodiment of the invention;

FIG. 4 is a schematic, perspective bottom view of the oscillating arm of FIG. 1;

FIGS. 5 and 6 relate to a schematic, perspective top and bottom view of the joint part of FIG. 1, respectively;

FIG. 7 shows a schematic side view, seen in cross-section, of the joint part/connecting device and the oscillating arm of FIG. 1 fitted together; and

FIG. 8 is a schematic cross-sectional view of the interconnection of the joint part/connecting device and the oscillating arm of FIG. 1.

### DETAILED DESCRIPTION

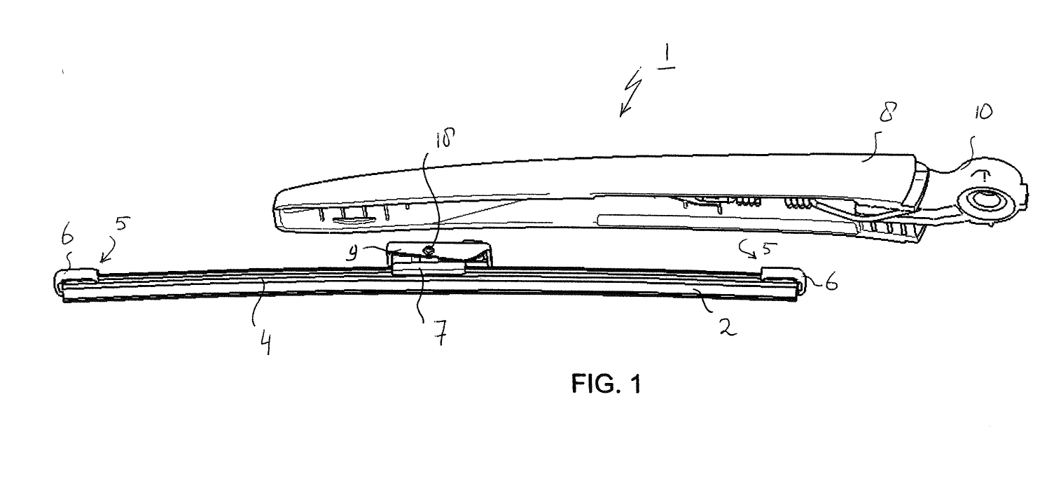

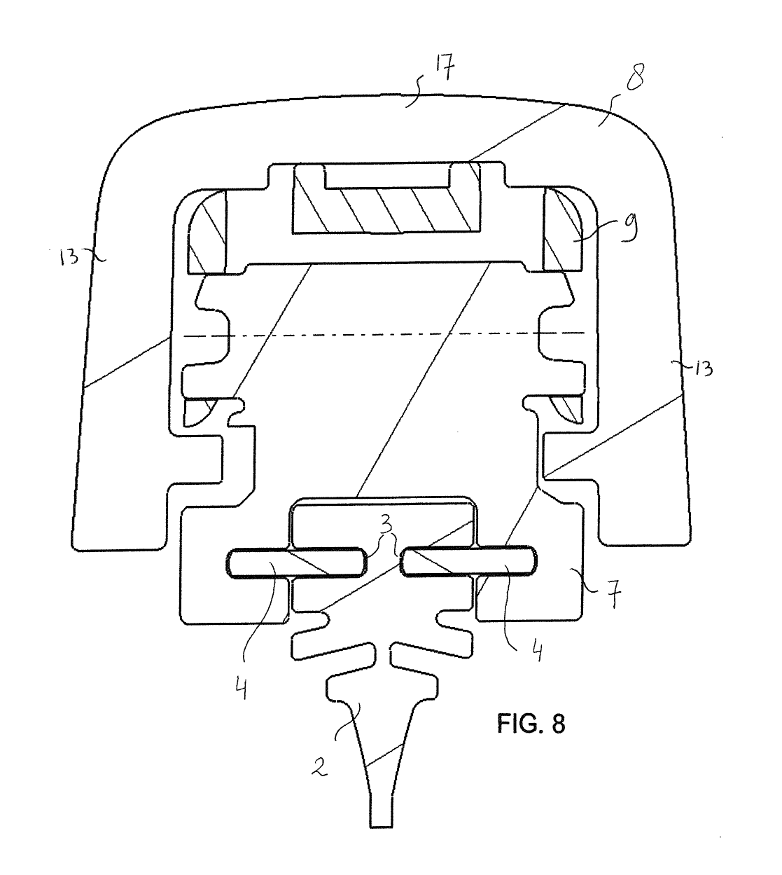

With reference to FIGS. 1 and 8, the windscreen wiper device 1 is built up of an elastomeric wiper blade 2, in the longitudinal sides of which opposing longitudinal grooves 3 are formed, and of longitudinal strips 4 made of spring band steel, which are fitted in the longitudinal grooves 3. the strips 4 form a flexible carrier element for the wiper blade 2, as it were, which is thus biased in a curved position (the curvature in operative position being that of a windscreen to be wiped). Neighboring ends 5 of the strips 4 at each end of the wiper blade 2 are interconnected by means of a connecting piece 6 or “end cap” functioning as clamping member. In this embodiment, the connecting pieces 6 are separate constructional elements, which may be form-locked (“positive locking” or “having a positive fit”) or force-locked to the ends 5 of the strips 4.

In another preferred embodiment, the connecting pieces 6 are in one piece with the strips 4 made of spring band steel. In the latter case each connecting piece 6 forms a transverse bridge for the strips 4, as it were.

The windscreen wiper device 1 is furthermore built up of a connecting device 7 of plastic material for pivotally connecting an oscillating arm 8 thereto, with the interposition of a plastic joint part 9. Alternatively, the connecting device 7 may also be made of metal, such as steel or aluminum. The connecting device 7 may comprise clamping members that are integral therewith, which engage around longitudinal sides of the strips 4 that face away from each other, as a result of which the connecting device 7 is firmly attached to the unit consisting of the wiper blade 2 and the strips 4.

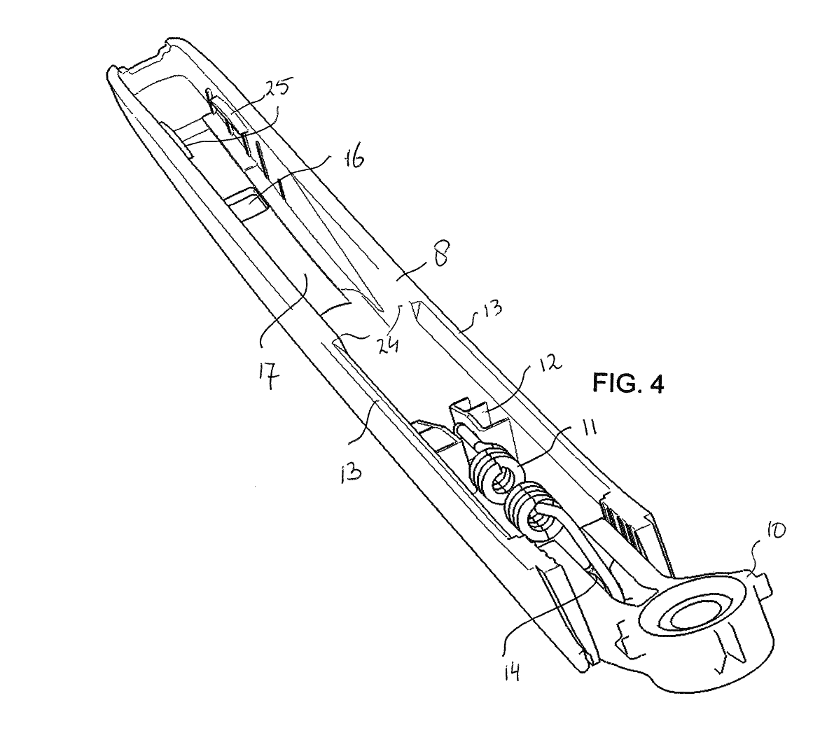

Although not illustrated in all detail, but clear to a person skilled in the art, the windscreen wiper device 1 according to the invention comprises a plastic or metallic mounting head 10 which can be fixed for rotation to a shaft (not illustrated) driven, via a mechanism not illustrated either, by a small motor. In use, the shaft rotates alternately in a clockwise and in a counter-clockwise sense carrying the mounting head 10 into rotation also, which in turn draws the oscillating arm 8 in rotation and thereby moves the connecting device 7 and thus the wiper blade 2 attached thereto. The mounting head 10 is detachably connected to the oscillating arm 8, as shown in FIG. 4. A spring 11 is hooked with its first end to a transverse bridge 12 between legs 13 of a U-shaped cross-section of the oscillating arm 8, whereas the spring 11 is hooked with its second end on a pin 14 on the mounting head 10 to ensure that the oscillating arm 8 and thus the wiper blade connected thereto is pressed onto a windscreen to be wiped.

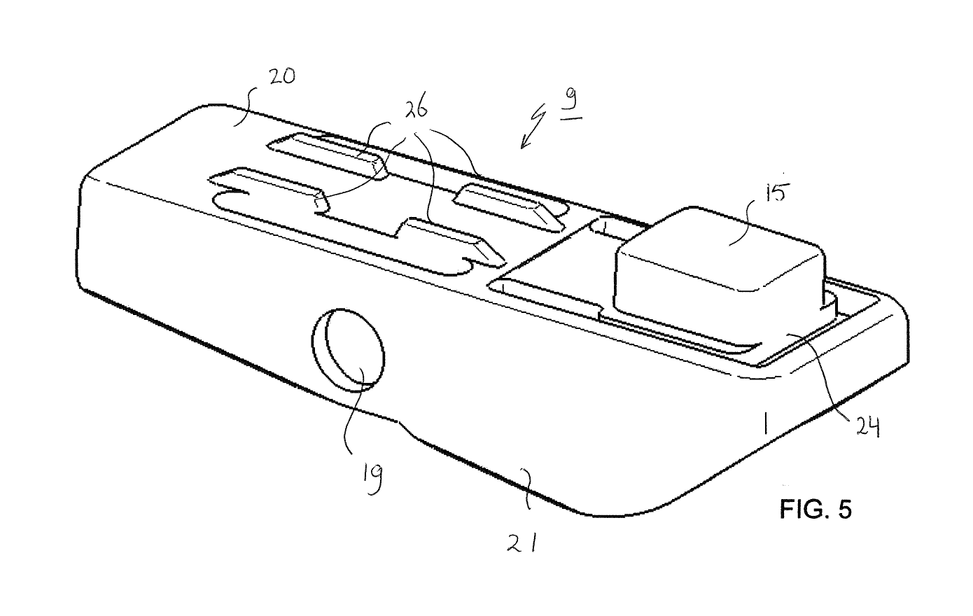

With reference to FIG. 5 the joint part 9 comprises one resilient tongue 15 extending outwardly, while the oscillating arm 8 has an U-shaped cross-section at the location of its connection to the joint part 9, so that the tongue 15 engages in an identically shaped hole 16 provided in a base 17 of the U-shaped cross-section.

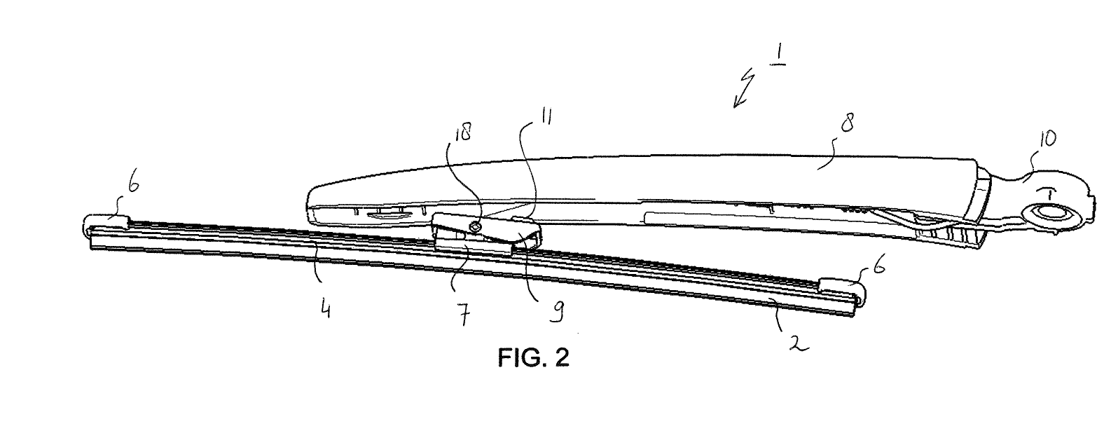

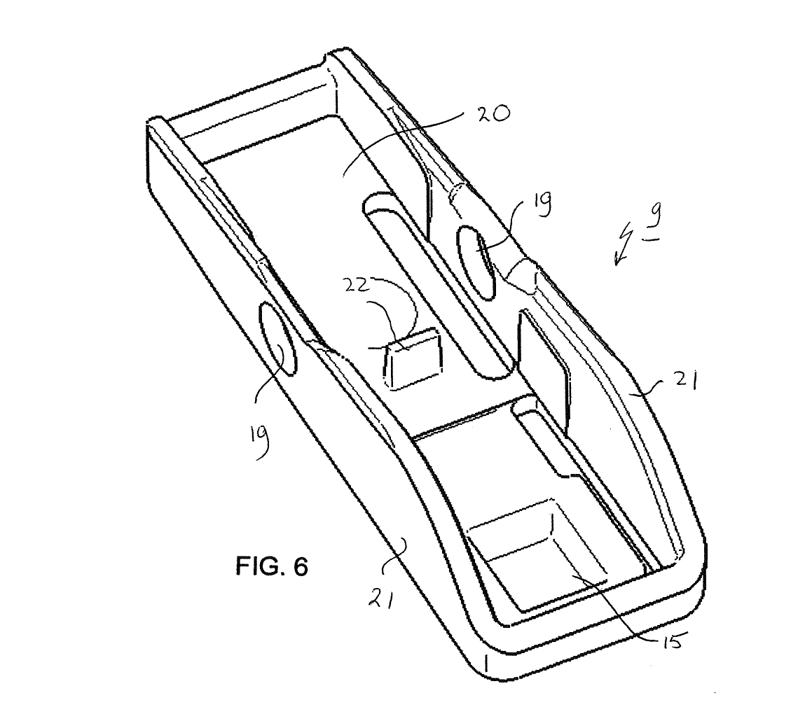

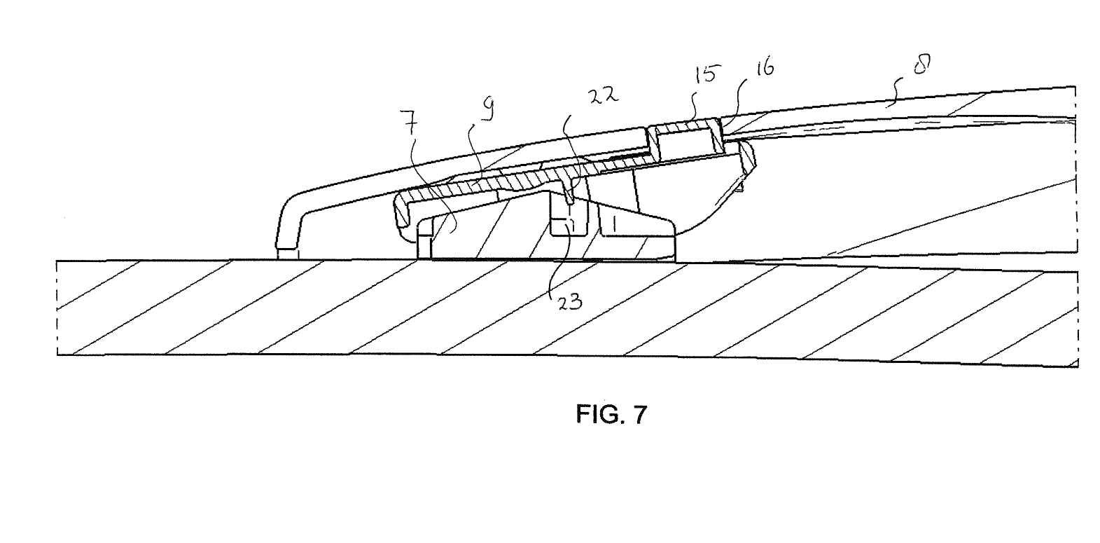

Referring to FIGS. 1, 2, 5, 6, 7 and 8 the connecting device 7 comprises two cylindrical protrusions 18 extending outwards on either side of the connecting device 7. These protrusions 18 pivotally engage in identically shaped cylindrical recesses 19 of the joint part 9. the protrusions 18 act as bearing surfaces at the location of a pivot axis in order to pivot the joint part 9 (and the oscillating arm 8 attached thereto) about the pivot axis near one end of the oscillating arm 8. The protrusions 18 are preferably in one piece with the connecting device 7. In the alternative, the protrusions 18 are part of a single pivot pin perpendicular to the connecting device 7. The joint part 9 has a U-shaped cross-section defining a base 20 and legs 21 (see FIGS. 5 and 6), wherein the base 20 comprises a downwardly extending lip 22 engaging into a correspondingly shaped recess 23 in the connecting device 7 in mounted position (see FIGS. 6 and 7).

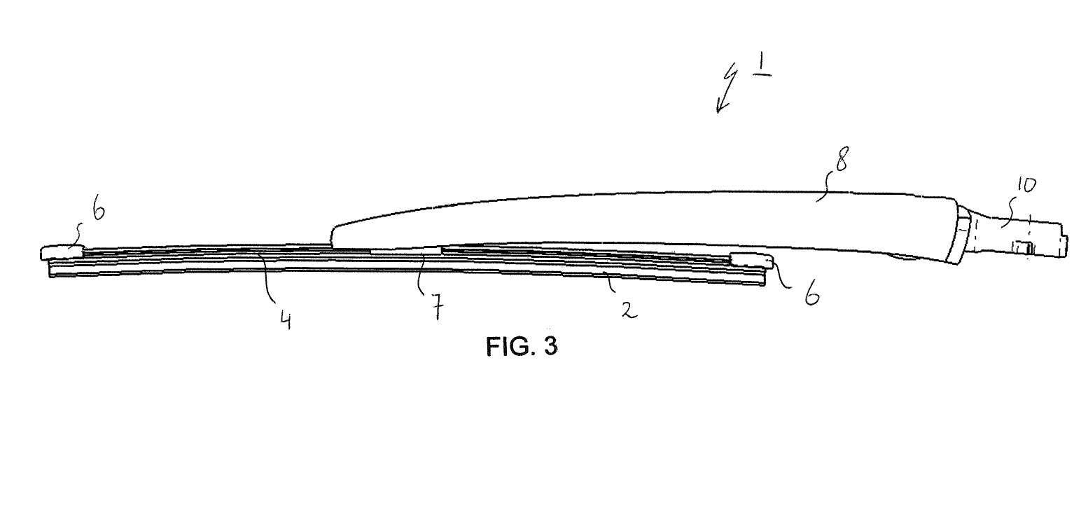

FIGS. 1, 2 and 3 show the steps of mounting the connecting device 7/joint part 9 with the wiper blade 2 onto the oscillating arm 8. the oscillating arm 8 and the joint part 9 are interconnected by introduction of the joint part 9 inside the U-shaped cross-section of the oscillating arm 8 at a location between the hole 16 provided in the oscillating arm 8 and the mounting head 10. During this sliding movement the resilient tongue 15 is initially pushed in against a spring force and then allowed to spring back into the hole 16, thus snapping, that is clipping the resilient tongue 15 into the hole 16. This is a so-called bayonet-connection. The oscillating arm 8 together with the wiper blade 2 is then ready for use. By subsequently pushing in again the resilient tongue 15 against the spring force (as if it were a push button), the connecting device 7/joint part 9 together with the wiper blade 2 may be released from the oscillating arm 8. Dismounting the connecting device 7/joint part 9 with the wiper blade 2 (not shown) from the oscillating arm 8 is thus realized by sliding the connecting device 7/joint part 9 together with the wiper blade 2 (not shown) in a direction away from the oscillating arm 8. In mounted position the joint part 9 and (only a very small part of) the connecting device 7 are visible from the outside (see FIG. 3). The hinge axis 24 of the joint part 9 is facing away from the free end of the oscillating arm 8 (see FIG. 5).

As can be seen from FIG. 4, the legs 13 of the U-shaped cross-section of the oscillating arm 8 comprises guiding means in the form of profiles 24 at a location between the hole 16 provided in the oscillating arm (8) and the mounting head 10 for guiding the joint part 9 inside the U-shaped cross-section of the oscillating arm 8. Wings 25 extending sidewardly and inwardly from the legs 13 of the U-shaped cross-section of the oscillating arm 8 form extra retention means for retaining the joint part 9 onto the oscillating arm 8 in transverse direction. The joint part 9 comprises a profile 26 on top of the base 20 of the U-shaped cross-section thereof forms extra retention means for retaining the joint part 9 onto the oscillating arm 8 in longitudinal direction.

The invention is not restricted to the variants shown in the drawing, but it also extends to other embodiments that fall within the scope of the appended claims.

1. A windscreen wiper device comprising an elastic, elongated carrier element, as well as an elongated wiper blade of a flexible material, which can be placed in abutment with a windscreen to be wiped, which wiper blade is of the flat blade type and includes at least one longitudinal groove, in which groove a longitudinal strip of the carrier element is disposed, which windscreen wiper device comprises a mounting head for transferring a reciprocal movement to said wiper blade, as well as a connecting device for an oscillating arm, wherein said oscillating arm is pivotally connected to said connecting device about a pivot axis near a free end thereof, with the interposition of a joint part, wherein said joint part comprises at least one resilient tongue engaging in a correspondingly shaped hole provided in said oscillating arm, and wherein said resilient tongue is rotatable along an hinge axis between an outward position retaining the wiper blade onto the oscillating arm and an inward position releasing the wiper blade from the oscillating arm, wherein said oscillating arm has an at least substantially U-shaped cross-section at the location of its connection to said joint part, and wherein said joint part is positioned at least substantially within the U-shaped cross-section of said oscillating arm,
wherein said oscillating arm and said joint part are interconnected by introduction of said joint part inside the U-shaped cross-section of said oscillating arm at a location between the hole provided in said oscillating arm and said mounting head.

2. The windscreen wiper device according to claim 1, wherein the U-shaped cross-section of said oscillating arm comprises guiding means at a location between the hole provided in said oscillating arm and said mounting head for guiding said joint part inside the U-shaped cross-section of said oscillating arm.

3. The windscreen wiper device according to claim 1, wherein the hinge axis of said joint part is facing towards the free end of said oscillating arm.

4. The windscreen wiper device according to claim 1, wherein the hinge axis of said joint part is facing away from the free end of said oscillating arm.

5. windscreen wiper device according to claim 1, wherein the hole of said oscillating arm is provided in a base of the U-shaped cross-section thereof.

6. The windscreen wiper device according to claim 5, wherein the hole has a closed circumference.

7. The windscreen wiper device according to claim 1, wherein said joint part is made of plastic.

8. The windscreen wiper device according to claim 1, wherein said joint part is attached to said connecting device by pivotally engaging protrusions of said connecting device, at the location of said pivot axis, in recesses provided in said joint part.

9. The windscreen wiper device according to claim 1, wherein said joint part has an at least substantially U-shaped cross-section at the location of its attachment to said connecting device, and wherein said joint part in each leg of said U-shaped cross-section is provided with a recess provided coaxially with said pivot axis.

10. The windscreen wiper device according to claim 8, wherein the protrusions extend outwards on either side of said connecting device, and wherein the protrusions are at least substantially cylindrical.
